(19) United States
(12) Patent Application Publication
(10) Pub. No.: US 2026/0014599 A1
(43) Pub. Date: Jan. 15, 2026

(54) TWO PIECE HOLLOW-VANE ASSEMBLY CLEANING SYSTEM

(71) Applicant: RTX Corporation, Farmington, CT (US)

(72) Inventors: David E. Bitter, Chester, CT (US); William John Oldach, West Hartford, CT (US)

(73) Assignee: RTX Corporation, Farmington, CT (US)

(21) Appl. No.: 18/771,561

(22) Filed: Jul. 12, 2024

(51) Int. Cl. B08B 9/00; F01D 5/18

(52) U.S. Cl. CPC B08B 9/00; F01D 5/18

(57) ABSTRACT

A hollow vane assembly cleaning system comprising: an open body having a single wall design defining an interior; at least one cleaning port formed in the open body proximate an exterior wall of the open body; at least one outlet port formed in the open body proximate the exterior wall of the open body; and a cover brazed to the open body to form at least one internal flow passage.

### BACKGROUND

The present disclosure is directed to a hollow vane with an open body and a cover cleaning system.

Hollow vanes are typically utilized to enable air, either hot or cold, to flow through the part to achieve a desired thermal effect.

Often this air is obtained through ‘bleeds’ within turbomachinery, such as a jet engine. Further, turbomachinery is prone to small particulate being ingested from external air (dust, dirt, debris, etc.) or from internal erosion (abradable seals, material wear, and the like).

As air is bled from the various stages of the machine, it can contain particulate that can become deposited within the hollow vane. This deposit can impact the flow of the air through the hollow vane which would negatively affect the thermal regulation of that part, as designed.

### SUMMARY

In accordance with the present disclosure, there is provided a process of cleaning a hollow vane assembly comprising forming an open body, the open body including an interior; forming at least one cleaning port and at least one outlet port in the open body proximate an exterior wall of the open body; attaching a cover to the open body to form at least one flow passage; flowing a cleaning fluid through the at least one flow passage; and removing debris from the at least one flow passage with the cleaning fluid.

A further embodiment of any of the foregoing embodiments may additionally and/or alternatively include the process further comprising forming the at least one cleaning port in a trunnion of the open body.

A further embodiment of any of the foregoing embodiments may additionally and/or alternatively include the at least one flow passage is configured as multiple cooling channels that allow for cooling fluid and cleaning fluid to flow through the interior.

A further embodiment of any of the foregoing embodiments may additionally and/or alternatively include the process further comprising forming an outlet port plug; and configuring the outlet port plug removably coupled to the outlet port.

A further embodiment of any of the foregoing embodiments may additionally and/or alternatively include the process further comprising configuring the at least one cleaning port with attachment hardware; and configuring the attachment hardware to operatively couple with a cleaning fluid supply conduit.

A further embodiment of any of the foregoing embodiments may additionally and/or alternatively include the process further comprising coupling the at least one cleaning port to a cleaning fluid supply conduit.

A further embodiment of any of the foregoing embodiments may additionally and/or alternatively include the process further comprising configuring the at least one cleaning port as a dual purpose port allowing a flow of cooling/heating air and/or a flow of cleaning fluid.

In accordance with the present disclosure, there is provided a hollow vane assembly cleaning system comprising an open body having a single wall design defining an interior; at least one cleaning port formed in the open body proximate an exterior wall of the open body; at least one outlet port formed in the open body proximate the exterior wall of the open body; and a cover brazed to the open body to form at least one internal flow passage.

A further embodiment of any of the foregoing embodiments may additionally and/or alternatively include the at least one cleaning port is configured with attachment hardware; and the attachment hardware is operatively coupled with a cleaning fluid supply conduit.

A further embodiment of any of the foregoing embodiments may additionally and/or alternatively include the at least one internal flow passage is configured as multiple cooling channels that allow for cooling fluid and cleaning fluid to flow through the interior.

A further embodiment of any of the foregoing embodiments may additionally and/or alternatively include the hollow vane assembly cleaning system further comprising an outlet port plug removably coupled to the outlet port.

A further embodiment of any of the foregoing embodiments may additionally and/or alternatively include the at least one cleaning port is configured as a dual purpose port allowing a flow of cooling/heating air and/or a flow of cleaning fluid.

A further embodiment of any of the foregoing embodiments may additionally and/or alternatively include the at least one cleaning port is formed in a trunnion of the open body.

In accordance with the present disclosure, there is provided a process for cleaning a hollow vane assembly for comprising forming an open body, the open body includes a leading edge opposite a trailing edge, the open body includes a pressure side and suction side opposite the pressure side, the open body including an interior; forming at least one cleaning port and at least one outlet port in the open body proximate an exterior wall of the open body; forming a cover, the cover being configured to couple with the open body proximate the pressure side to form at least one flow passage; attaching the cover to the open body; fluidly coupling a cleaning fluid supply to the at least one cleaning port; flowing a cleaning fluid through the at least one flow passage; and removing debris from the at least one flow passage with the cleaning fluid.

A further embodiment of any of the foregoing embodiments may additionally and/or alternatively include the process further comprising opening the at least one outlet port; removing an outlet port plug; discharging the cleaning fluid and entrained debris through the at least one outlet port.

A further embodiment of any of the foregoing embodiments may additionally and/or alternatively include the process further comprising configuring the at least one cleaning port as a dual purpose port allowing a flow of cooling/heating air and/or a flow of cleaning fluid.

A further embodiment of any of the foregoing embodiments may additionally and/or alternatively include the process further comprising configuring the at least one cleaning port with attachment hardware; and configuring the attachment hardware to operatively couple with a cleaning fluid supply conduit.

A further embodiment of any of the foregoing embodiments may additionally and/or alternatively include the process further comprising forming an outlet port plug; and configuring the outlet port plug removably coupled to the outlet port.

A further embodiment of any of the foregoing embodiments may additionally and/or alternatively include the process further comprising forming the at least one flow passage as multiple cooling channels that allow for cooling fluid and cleaning fluid to flow through the interior.

A further embodiment of any of the foregoing embodiments may additionally and/or alternatively include the process further comprising forming the at least one cleaning port in a trunnion of the open body.

Other details of the hollow vane assembly cleaning system are set forth in the following detailed description and the accompanying drawings wherein like reference numerals depict like elements.

### BRIEF DESCRIPTION OF THE DRAWINGS

FIG. 1 is a cross section view of an exemplary gas turbine engine.

FIG. 2 is a schematic representation of an exemplary vane assembly.

FIG. 3 is a schematic representation of the exemplary vane assembly of FIG. 2.

FIG. 4 is a schematic representation of an exemplary vane body.

FIG. 5 is a schematic representation of a portion of the exemplary vane body of FIG. 4.

FIG. 6 is a schematic representation of a portion of the exemplary vane body of FIG. 4.

FIG. 7 is an exemplary process map.

### DETAILED DESCRIPTION

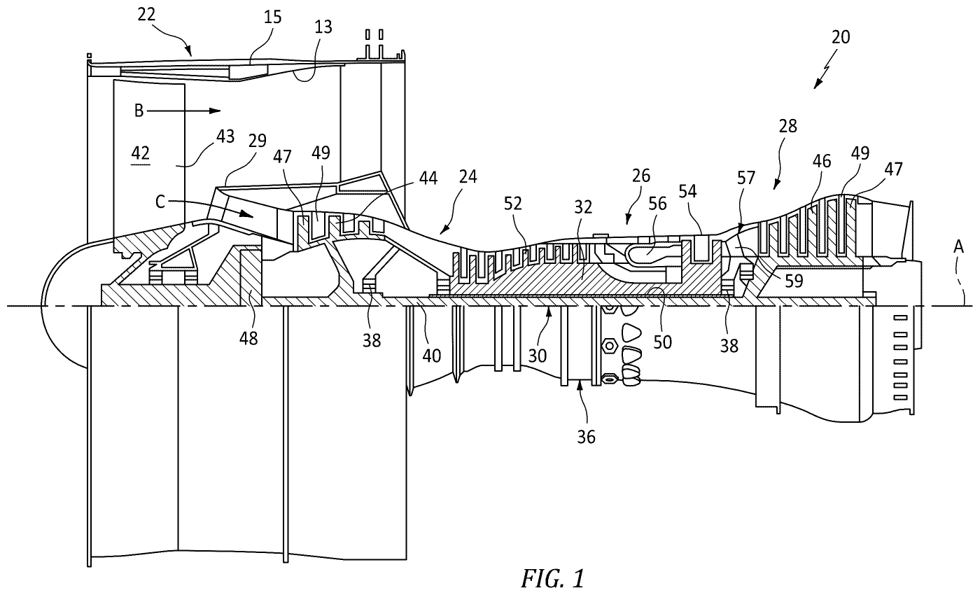

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 may include a single-stage fan 42 having a plurality of fan blades 43. The fan blades 43 may have a fixed stagger angle or may have a variable pitch to direct incoming airflow from an engine inlet. The fan 42 drives air along a bypass flow path B in a bypass duct 13 defined within a housing 15 such as a fan case or nacelle, and also drives air along a core flow path C for compression and communication into the combustor section 26 then expansion through the turbine section 28. A splitter 29 aft of the fan 42 divides the air between the bypass flow path B and the core flow path C. The housing 15 may surround the fan 42 to establish an outer diameter of the bypass duct 13. The splitter 29 may establish an inner diameter of the bypass duct 13. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to the fan 42 through a speed change mechanism, which in the exemplary gas turbine engine 20 is illustrated as a geared architecture 48 to drive the fan 42 at a lower speed than the low speed spool 30. The inner shaft 40 may interconnect the low pressure compressor 44 and low pressure turbine 46 such that the low pressure compressor 44 and low pressure turbine 46 are rotatable at a common speed and in a common direction. In other embodiments, the low pressure turbine 46 drives both the fan 42 and low pressure compressor 44 through the geared architecture 48 such that the fan 42 and low pressure compressor 44 are rotatable at a common speed. Although this application discloses geared architecture 48, its teaching may benefit direct drive engines having no geared architecture. The high speed spool 32 includes an outer shaft 50 that interconnects a second (or high) pressure compressor 52 and a second (or high) pressure turbine 54. A combustor 56 is arranged in the exemplary gas turbine 20 between the high pressure compressor 52 and the high pressure turbine 54. A mid-turbine frame 57 of the engine static structure 36 may be arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

Airflow in the core flow path C is compressed by the low pressure compressor 44 then the high pressure compressor 52, mixed and burned with fuel in the combustor 56, then expanded through the high pressure turbine 54 and low pressure turbine 46. The mid-turbine frame 57 includes airfoils 59 which are in the core flow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan 42 may be positioned forward or aft of the location of gear system 48.

The low pressure compressor 44, high pressure compressor 52, high pressure turbine 54 and low pressure turbine 46 each include one or more stages having a row of rotatable airfoils. Each stage may include a row of static vanes adjacent to the rotatable airfoils. The rotatable airfoils and vanes are schematically indicated at 47 and 49.

The engine 20 may be a high-bypass geared aircraft engine. The bypass ratio can be greater than or equal to 10.0 and less than or equal to about 18.0, or more narrowly can be less than or equal to 16.0. The geared architecture 48 may be an epicyclic gear train, such as a planetary gear system or a star gear system. The epicyclic gear train may include a sun gear, a ring gear, a plurality of intermediate gears meshing with the sun gear and ring gear, and a carrier that supports the intermediate gears. The sun gear may provide an input to the gear train. The ring gear (e.g., star gear system) or carrier (e.g., planetary gear system) may provide an output of the gear train to drive the fan 42. A gear reduction ratio may be greater than or equal to 2.3, or more narrowly greater than or equal to 3.0, and in some embodiments the gear reduction ratio is greater than or equal to 3.4. The gear reduction ratio may be less than or equal to 4.0. The fan diameter is significantly larger than that of the low pressure compressor 44. The low pressure turbine 46 can have a pressure ratio that is greater than or equal to 8.0 and in some embodiments is greater than or equal to 10.0. The low pressure turbine pressure ratio can be less than or equal to 13.0, or more narrowly less than or equal to 12.0. Low pressure turbine 46 pressure ratio is pressure measured prior to an inlet of low pressure turbine 46 as related to the pressure at the outlet of the low pressure turbine 46 prior to an exhaust nozzle. It should be understood, however, that the above parameters are only exemplary of one embodiment of a geared architecture engine and that the present invention is applicable to other gas turbine engines including direct drive turbofans. All of these parameters are measured at the cruise condition described below.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of pounds-mass per hour lbm/hr of fuel flow rate being burned divided by pounds-force lbf of thrust the engine produces at that minimum point. The engine parameters described above, and those in the next paragraph are measured at this condition unless otherwise specified.

“Low fan pressure ratio” is the pressure ratio across the fan blade 43 alone, without a Fan Exit Guide Vane (“FEGV”) system. A distance is established in a radial direction between the inner and outer diameters of the bypass duct 13 at an axial position corresponding to a leading edge of the splitter 29 relative to the engine central longitudinal axis A. The low fan pressure ratio is a spanwise average of the pressure ratios measured across the fan blade 43 alone over radial positions corresponding to the distance. The low fan pressure ratio can be less than or equal to 1.45, or more narrowly greater than or equal to 1.25, such as between 1.30 and 1.40. “Low corrected fan tip speed” is the actual fan tip speed in ft/sec divided by an industry standard temperature correction of [(Tram ° R)/(518.7° R)]^{0.5}. The “low corrected fan tip speed” can be less than or equal to 1150.0 ft/second (350.5 meters/second), and greater than or equal to 1000.0 ft/second (304.8 meters/second).

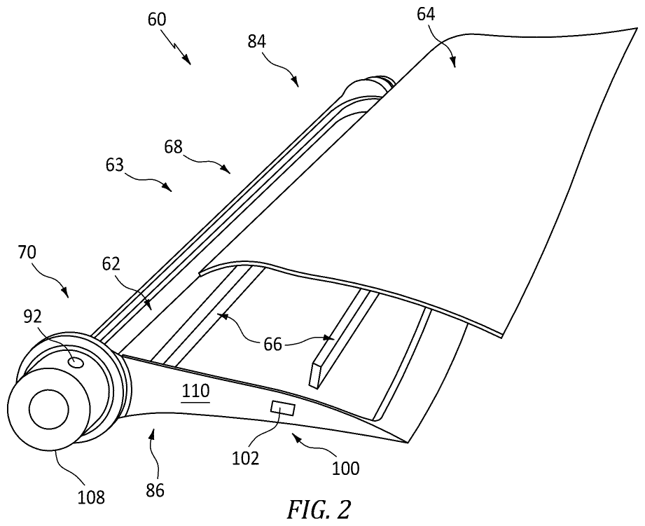

Referring also to FIG. 2 shows an exemplary two piece hollow-vane assembly 60. The hollow-vane assembly 60 includes an open body 62 that can be a single piece design, being completely integral or monolithic. The two piece hollow-vane assembly 60 includes a cover 64 that is attachable to the open body 62. The open body 62 includes cover support structure(s) 66. The open body 62 and cover 64 are combined to form an airfoil 68 of a vane 70 when brazed together. The open body 62 and cover 64 are configured as a single wall structure 63 as opposed to a double wall structure vane configuration with two interior chambers divided by an interior wall and contained within an exterior wall structure. It is contemplated that the hollow-vane assembly 60 be configured as a structure having contoured surfaces, such as a turbine blade. The hollow-vane assembly 60 can include a three dimensionally contoured shape. The three dimensional contoured surface can refer to a surface defined by an X, Y, and Z axis. The three dimensional contoured surface can vary from point to point to include surface variation of X, Y and Z coordinates.

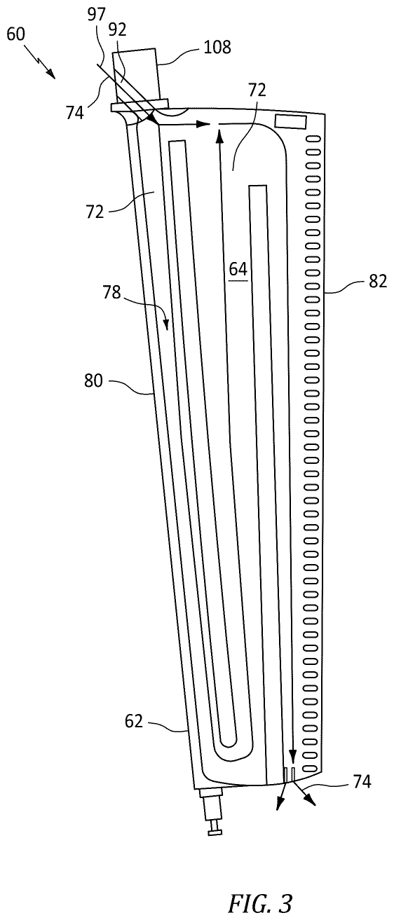

Referring also to FIG. 3 the exemplary vane assembly 60 is shown. The vane assembly 60 is shown with representative fluid flow passages 72 with flow arrows 74. The flow arrows 74 show an exemplary cooling/heating fluid 76 flow through the fluid flow passages 72 at the interior 78 formed by the open body 62 and cover 64. The flow passages 72 can be configured as multiple cooling channels 72 that allow for cooling fluid 76 to flow through the interior 78.

The open body 62 and cover 64 can be constructed from rigid materials, such as a metal alloy and in alternative embodiments, from heat resistant super alloy composition, nickel-based, or cobalt based compositions. The open body 62 and cover 64 can be made of the same material or different materials.

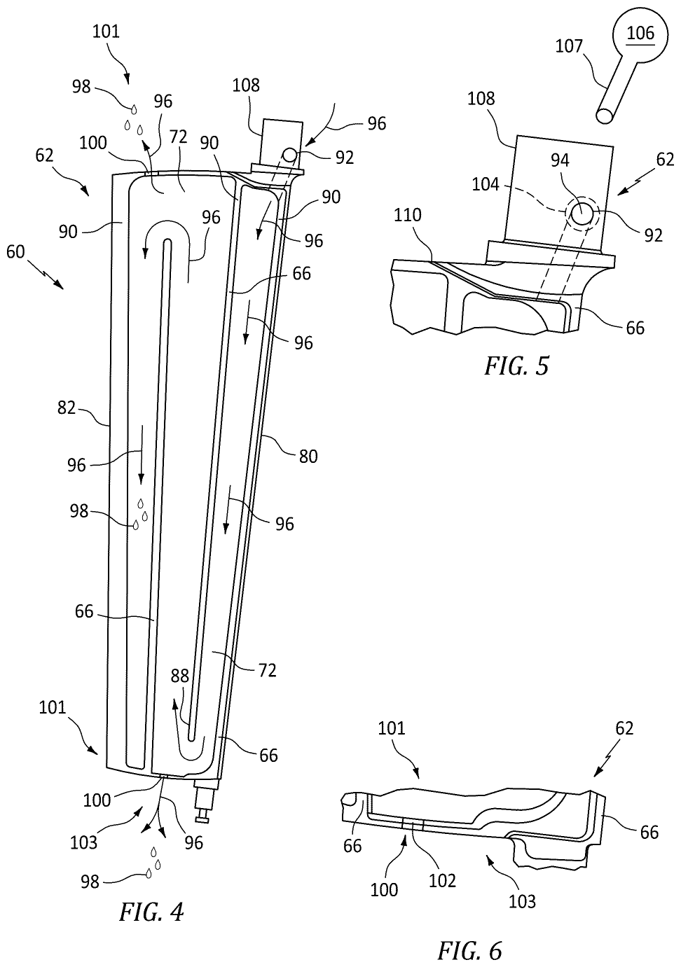

Referring also to FIGS. 2, 4, 5, and 6 the details of the open body 62 are shown. The open body 62 can be formed from a casting, for example. The open body 62 can include a leading edge 80 opposite a trailing edge 82, a pressure side 86 and suction side 84 opposite the pressure side 86 (FIG. 2). The open body 62 including the cover support structures 66 allow for the formation of the flow passages 72. The cover support structure 66 can form an interior wall 88. The cover support structure 66 can be raised surface features of the open body 62. The cover support structure 66 can extend from the open body 62 distally.

The cover support structure 66 can form parts of the flow passages 72 along with the cover 64 and open body 62. The open body 62 with integral cover support structure(s) 66 can be manufactured via a manufacturing process that supports the geometric and material capability needs of the vane 60. Potential manufacturing options for the open body 62 can include casting, additive manufacturing, or conventional machining.

Once the open body 62 is manufactured all surfaces of the vane 60, including the now exposed interior 78 of the open body 62, can be post processed to achieve the desired metallurgical properties.

In parallel to the manufacturing of the open body 62, the cover 64 can be fabricated. In addition to the manufacturing options available for the open body 62 the cover 64 can be formed to the desired geometry via conventional metal forming methods like stamping, deep drawing, or hydroforming, and machining via multi-axis CNC. Similarly to the open body 62, post processing of all part surfaces may be performed on the cover 64 to achieve the desired metallurgical properties.

With both the open body 62 and cover 64 fabrication completed the cover 64 can be permanently joined to the open body 62 via brazing. Any subsequent heat treatment, final finishing, inspections, etc. can follow the brazing.

Referring also to FIG. 3 through FIG. 6, exemplary brazing joints 90 are shown the brazing joint 90 proximate the trailing edge 82 where the cover 64 and open body 62 join together. A cleaning port 92 is formed in the open body 62. The cleaning port 92 can be configured as an inlet 94 for receiving a cleaning fluid 96. The cleaning port 92 can also serve a dual purpose of allowing the flow of cooling/heating air 97 and/or the cleaning fluid 96. The cleaning fluid 96 can include air, water, chemical solutions, and the like that can dislodge, break down, dissolve and/or entrain debris 98 found within the flow passages 72. The cleaning fluid 96 is configured to flow within the flow passages 72 and remove the debris 98 from the flow passages 72.

Outlet ports 100 can be formed in the open body 62 at various locations that allow for the discharge of the cleaning fluid 96 and entrained debris 98. The outlet port 100 can be plugged with an outlet port plug 102. The outlet port plug 102 can be configured removable from the outlet port 100. At a time when the cleaning fluid 96 is to be flushed through the flow passages 72, the outlet port plug 102 can be removed. The outlet port plug 102 can be reinserted during normal operating conditions. The outlet port plug 102 can be a threaded device configured to be removed and inserted via threads or other secure structure, rings, pins, latches, and the like within the outlet port 100. The outlet ports 100 can be placed in strategic locations 101 that allow for cleaning fluid 96 to flow through the flow passages 72 as well as flush out the unwanted debris 98 without the need for high pressure driving the cleaning fluid 96. The strategic locations 101 can be located downstream of the cleaning port 92 distally from the cleaning port 92, such as a vane tip 103 opposite the trunnion 108 or near places where the cleaning fluid 96 would have lower velocity or near locations that allow for discharge of the cleaning fluid 96 outside of the interior 78 to be collected for disposal.

The cleaning port 92 can be configured with attachment hardware 104 configured to operatively couple with a cleaning fluid supply 106 (FIG. 5). The cleaning fluid supply 106 includes a cleaning fluid supply conduit 107 configured to fluidly couple with the cleaning port 92 via the attachment hardware 104. The attachment hardware 104 can be quick connect fixtures, hose connection fixture, threaded fixtures and the like.

In the embodiment shown, the cleaning port 92 is formed in a trunnion 108 of the vane 70. It is contemplated that the cleaning port 92 can be located along the exterior wall 110 of the open body 62 at a variety of locations that allow for coupling to the cleaning fluid supply conduit 106.

The internal flow passages 72 of the hollow vane assembly 60 can be cleaned by fluidly coupling the cleaning fluid supply conduit 106 with at least one cleaning port 92 configured to fluidly couple with the flow passages 72 internal to the hollow vane assembly 60. The outlet ports 100 can be opened by removing the outlet port plugs 102 to allow for the discharge of the cleaning fluid 96 and entrained debris 98. The outlet port plugs 102 can be reinstalled to prep the hollow vane assembly 60 for normal operation.

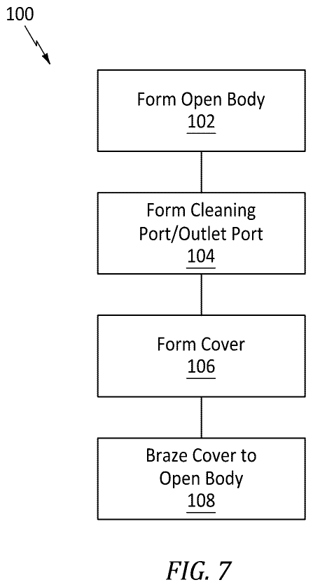

Referring also to FIG. 7 a process map showing the process 100. The process 100 can include the step 102 of forming the open body 62. The next step 104 can include forming the cleaning port 92 and outlet port 100 in the open body 62. The next step 106 can include forming the cover 64. The next step 108 can include brazing the cover 64 to the open body 62. The cover support structure 66 can be coupled to the cover 64 by brazing.

A technical advantage of the disclosed hollow vane assembly includes the selection of a manufacturing method that meets the geometric requirements of the hardware while reducing the metallurgical shortfalls imposed when casting hollow vanes.

Another technical advantage of the disclosed hollow vane assembly cleaning system includes direct machining access within the internal passageways of the vane.

Another technical advantage of the disclosed hollow vane assembly cleaning system includes not being restricted to castable features or geometry that allows for diffusion bonding.

Another technical advantage of the disclosed hollow vane assembly cleaning system includes capacity to optimize ice protection air flow.

Another technical advantage of the disclosed hollow vane assembly cleaning system includes capacity to optimize the geometry for strength/weight.

Another technical advantage of the disclosed hollow vane assembly cleaning system includes capacity to alter the internal structure.

Another technical advantage of the disclosed hollow vane assembly cleaning system includes capacity to modify the modal response of the airfoil.

Another technical advantage of the disclosed hollow vane assembly cleaning system includes the ability to perform low-cost flush operations to remove debris from internal passageways of the hollow airfoil during engine maintenance or overhaul.

Another technical advantage of the disclosed hollow vane assembly cleaning system includes the ability to restore the flow capacity of the internal flow passageways to original design values.

Another technical advantage of the disclosed hollow vane assembly cleaning system includes the prevention of part obsolescence due to clogged internal passages.

Another technical advantage of the disclosed hollow vane assembly cleaning system includes the benefit of locating the cleaning port at an air supply inlet for production engines where cleaning is infrequent and waterfalls/dams on the stator surface are unwanted.

Another technical advantage of the disclosed hollow vane assembly cleaning system includes the inclusion of additional cleaning ports beneficial for conceptual testing where frequent cleaning is preferred.

There has been provided a hollow vane assembly cleaning system. While the hollow vane assembly cleaning system has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A process of cleaning a hollow vane assembly comprising:
forming an open body, the open body including an interior;
forming at least one cleaning port and at least one outlet port in the open body proximate an exterior wall of the open body;
attaching a cover to the open body to form at least one flow passage;
flowing a cleaning fluid through the at least one flow passage; and
removing debris from the at least one flow passage with the cleaning fluid.

2. The process according to claim 1, further comprising:
forming the at least one cleaning port in a trunnion of the open body.

3. The process according to claim 2, wherein the at least one flow passage is configured as multiple cooling channels that allow for cooling fluid and cleaning fluid to flow through the interior.

4. The process according to claim 1, further comprising:
forming an outlet port plug; and
configuring the outlet port plug removably coupled to the outlet port.

5. The process according to claim 1, further comprising:
configuring the at least one cleaning port with attachment hardware; and
configuring the attachment hardware to operatively couple with a cleaning fluid supply conduit.

6. The process according to claim 1, further comprising:
coupling the at least one cleaning port to a cleaning fluid supply conduit.

7. The process according to claim 1, further comprising:
configuring the at least one cleaning port as a dual purpose port allowing a flow of cooling/heating air and/or a flow of cleaning fluid.

8. A hollow vane assembly cleaning system comprising:
an open body having a single wall design defining an interior;
at least one cleaning port formed in the open body proximate an exterior wall of the open body;
at least one outlet port formed in the open body proximate the exterior wall of the open body; and
a cover brazed to the open body to form at least one internal flow passage.

9. The hollow vane assembly cleaning system according to claim 8, wherein the at least one cleaning port is configured with attachment hardware; and
the attachment hardware is operatively coupled with a cleaning fluid supply conduit.

10. The hollow vane assembly cleaning system according to claim 8, wherein the at least one internal flow passage is configured as multiple cooling channels that allow for cooling fluid and cleaning fluid to flow through the interior.

11. The hollow vane assembly cleaning system according to claim 8, further comprising:
an outlet port plug removably coupled to the outlet port.

12. The hollow vane assembly cleaning system according to claim 8, wherein the at least one cleaning port is configured as a dual purpose port allowing a flow of cooling/heating air and/or a flow of cleaning fluid.

13. The hollow vane assembly cleaning system according to claim 8, wherein the at least one cleaning port is formed in a trunnion of the open body.

14. A process for cleaning a hollow vane assembly for comprising:
forming an open body, the open body includes a leading edge opposite a trailing edge, the open body includes a pressure side and suction side opposite the pressure side, the open body including an interior;
forming at least one cleaning port and at least one outlet port in the open body proximate an exterior wall of the open body;
forming a cover, the cover being configured to couple with the open body proximate the pressure side to form at least one flow passage;
attaching the cover to the open body;
fluidly coupling a cleaning fluid supply to the at least one cleaning port;
flowing a cleaning fluid through the at least one flow passage; and
removing debris from the at least one flow passage with the cleaning fluid.

15. The process of claim 14, further comprising:
opening the at least one outlet port;
removing an outlet port plug;
discharging the cleaning fluid and entrained debris through the at least one outlet port.

16. The process of claim 14, further comprising:
configuring the at least one cleaning port as a dual purpose port allowing a flow of cooling/heating air and/or a flow of cleaning fluid.

17. The process of claim 14, further comprising:
configuring the at least one cleaning port with attachment hardware; and
configuring the attachment hardware to operatively couple with a cleaning fluid supply conduit.

18. The process of claim 14, further comprising:
forming an outlet port plug; and
configuring the outlet port plug removably coupled to the outlet port.

19. The process of claim 14, further comprising:
forming the at least one flow passage as multiple cooling channels that allow for cooling fluid and cleaning fluid to flow through the interior.

20. The process of claim 14, further comprising:
forming the at least one cleaning port in a trunnion of the open body.
